(19) United States
(12) Patent Application Publication
(10) Pub. No.: US 2014/0299039 A1
(43) Pub. Date: Oct. 9, 2014

(54) SHIPPING METHOD FOR CO2 STORAGE AND IMPORT OF CNG

(71) Applicant: Jacques François André Trollux, Paris (FR)

(72) Inventor: Jacques François André Trollux, Paris (FR)

(73) Assignee: STAMICARBON B.V., Sittard (NL)

(21) Appl. No.: 14/239,523

(22) PCT Filed: Aug. 17, 2012
(86) PCT No.: PCT/NL2012/050576

§ 371 Date: Apr. 3, 2014

(30) Foreign Application Priority Data
Aug. 18, 2011 (EP) 11177950.0

(51) Int. Cl. B63B 25/14; F17C 1/00; B63B 27/24

(52) U.S. Cl. CPC B63B 25/14; B63B 27/24; F17C 1/002
USPC 114/74 R

(57) ABSTRACT

Disclosed is a method of transporting CO₂ by ship for the purpose of storage in the ocean. The CO₂ is transported at a temperature between −25° C. and +25° C., and under a pressure that is sufficiently high for the CO₂ to be in a liquid or supercritical state. The choice of temperature/pressure conditions for the CO₂ enables the transport of CO₂ one way to be effectively combined with transport of compressed natural gas (CNG) the other way. Ships can be used that have relatively cheap tubular containment equipment similar to the type normally used for CNG but with lower pressure and not subject to cyclic thermal and mechanical effects of pressurizing and depressurizing.

### FIELD OF THE INVENTION

The invention pertains to a method of transport and off-shore underground storage of carbon dioxide (CO₂). The invention particularly pertains to a method of shipping and storage of CO₂ in conjunction with shipping of compressed natural gas on the return trip.

### BACKGROUND OF THE INVENTION

Carbon dioxide (CO₂) is an inevitable product of the burning of fossil fuels. These gas emissions, frequently referred to as “greenhouse gases,” are acknowledged to contribute substantially to global warming. Hence, it is desired to prevent, or at least reduce, CO₂ emission.

One method to achieve this is sequestration of CO₂ Herein the CO₂ is captured and stored in a location where it can be considered to be closed-off in a safe way, such as in underground structures.

Despite the desire to reduce greenhouse gas emission, which is well acknowledged in society at large, the sequestration of CO₂ in underground structures in or nearby inhabited areas frequently results in safety concerns, public opposition, and political unwillingness. A practical solution that has emerged, is storage of captured CO₂ in the ocean. This generally refers to reinjection into off-shore closures such as depleted oil and gas reservoirs, or other closed geological structures, e.g. an aquifer, or to using it for gas injection in an active oil field, for the purpose of Enhanced Oil Recovery (EOR).

Whilst this serves to avoid the environmental and permit problems of reinjection in on-shore structures, it comes with practical and economical disadvantages of the need to transport the carbon dioxide over large distances, by sea. Such transport can be done by pipeline, but the distance to the location, or the technical difficulties to lay a pipe line will mean that transport had better be done by ship.

The presently conventional scheme considered to transport CO₂ in large quantities, when the distance is not economical for an off shore pipeline, is to liquefy the CO₂ gas arriving under pressure by pipe at a location on the shore where it is convenient to build an export shipping terminal. The CO₂ is then stored in refrigerated liquid state at moderate pressure (typically around −40° C. 7-8 bars). It could then be loaded in a ship's containment system, which is generally consisting of insulated large spheres or multilobal tanks. Arriving at the off-shore location, the liquid cold CO₂ must be transferred by the ship's pumps to a reinjection platform, possibly after storing and reheating in a floating receiving terminal.

It is desired to provide a method by which the handling of the carbon dioxide, preferably at both ends of the shipping, can be simplified.

Further, it would be desired if a method could be found to enhance the economical efficiency of the off-shore sequestration operation.

### SUMMARY OF THE INVENTION

In order to better address one or more of the foregoing desires, the invention, in one aspect, provides a method for transporting captured carbon dioxide (CO₂) to an off-shore location, wherein the CO₂ is transported by ship, with the CO₂ being at a temperature between −25° C. and +25° C., and under a pressure that is sufficiently high for the CO₂ to be in a liquid state, wherein the transport of CO₂ is combined with transport of compressed natural gas (CNG), such that one way a ship transports CO₂ and the reverse way the ship transports the CNG, wherein one or more ships are used having tubular containment equipment for the storage of CO₂, and wherein the CO₂ and the CNG have substantially the same pressure.

The invention, in another aspect, is a method for transporting captured carbon dioxide to an off-shore location and transporting compressed natural gas (CNG) retrieved at or near said off-shore location, wherein the CO₂ is transported by ship as defined above, and wherein, at the off-shore location, the CNG replaces the CO₂ contained in the ship.

The invention, in yet another aspect, presents the use of a ship comprising a tubular system suitable for containment of compressed natural gas, for the transport of CO₂ in a liquid state.

### BRIEF DESCRIPTION OF THE DRAWINGS

FIG. 1 shows the phase-diagram of carbon dioxide;

FIG. 2 depicts a schematic set-up of the existing refrigerated transport of CO₂;

FIG. 3 depicts a schematic set-up of the export terminal for receiving and shipping liquid carbon dioxide in accordance with the invention;

FIG. 4 represents a simplified scheme for the off-shore unloading of liquid CO₂ in a method of the invention;

FIG. 5 shows a simplified scheme for an export terminal having a push pull storage for the exchange of CO₂ and CNG;

FIG. 6 shows a simplified scheme for an off-shore receiving facility having a push pull storage for the exchange of CO₂ and CNG;

FIG. 7 is an example of a scheme for a combined CO₂ export and CO₂ import shuttle operation;

A reference list for the drawings is added to this description.

### DETAILED DESCRIPTION OF THE INVENTION

In a general sense, the invention is based on the judicious insight to carry through a fundamental change in the conditions of temperature and pressure applied during transportation of carbon dioxide by ship, as compared to the regular refrigerated transport. The change, according to the invention, to shipping of CO₂ from refrigerated conditions to a temperature between −25° C. and +25° C., comes with fundamental advantages, and opens up a range of possibilities to improve the practical and economical sides of carbon dioxide sequestration.

The latter is even further improved, by virtue of the combination of CO₂ transport and back-transport of CNG. As further explained below, in a preferred embodiment the latter is done at elevated pressure, so as to enhance the capacity of CNG. This is preferably done in combination with about the same conditions for pressure and temperature of the CO₂, as this will allow a simple displacement of one gas by the other, without complicated equipment and pumps.

The transport at the aforementioned temperature is distinguished from the standard refrigerated transport, which requires specific measures (cooling and insulation) to keep the CO₂ at the typical refrigerated temperatures that are well below temperature range of the invention, e.g. −40° C. The temperature range used in the method of the invention is preferably determined at the stage of loading the CO₂ (and, when applicable the CNG) into the ship. This is thus preferably at a temperature between −25° C. and +25° C. Thereafter preferably no temperature control, other than insulated storage, is applied. In a preferred embodiment, the temperature, preferably when determined at the onset, i.e. when pumping the CO₂ into the ship, is in the range of from −15° C. to 10° C., more preferably −10° C. to +5° C., and most preferably −8° C. to 0° C. An advantage of choosing a temperature range below outdoor temperature, say at or below 0° C., is that it provides a higher CO₂ gravity which provides an advantageously higher storage capacity as compared to the gravity at e.g. a higher temperature and lower pressure,

Methods and equipment to obtain the cooling are known in the art. These could be evaporating-condensing cycle, using CO₂ or another liquid refrigerant or these could be based on a compression-expansion cycle of gas.

The choice of the temperature results from an optimization between the ship's transport capacity and complexity on the terminal. For instance −8° C. allows a good balancing of cold between CNG and CO₂ inlet and outlet. This allows to limit the additional cooling to the one provided by this balance, to some uncomplicated turbo-gas expanders process.

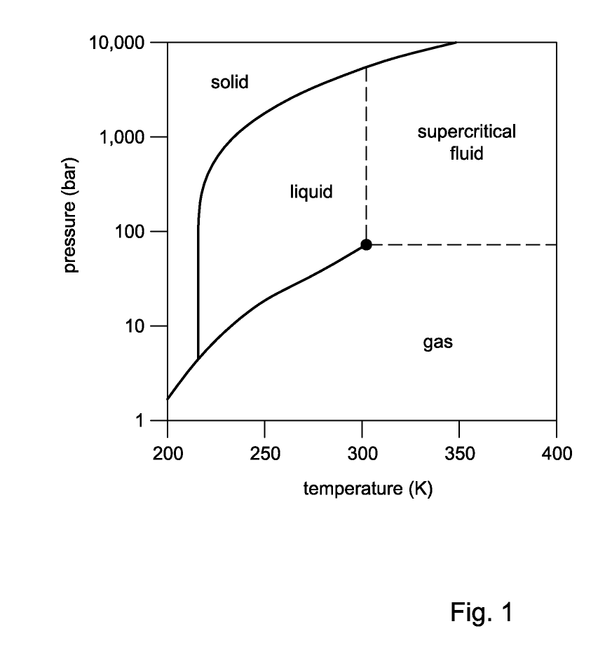

The phase-diagram of carbon dioxide is well-known to the skilled person. It is depicted in FIG. 1. The triple point is slightly above 5 bars at −56° C. and the critical pressure is 73 bar. Above the critical pressure, increasing the temperature will not cause a fluid to vaporize to give a two-phase system.

In the present invention the pressure applied to the CO₂ is sufficiently high for the CO₂ to be in a liquid state. The “liquid state” includes both the “liquid” and the “supercritical” phases in the phase diagram.

It will be understood that, under the temperature conditions for the CO₂ transport contemplated, the liquid CO₂ is at pressures where it forms a single-phase system.

In a preferred embodiment, the pressure is above the critical pressure. A high pressure, whilst increasing the costs of the pipe containment system, will serve to increase the capacity in CNG on the back trip, for a given CO₂ capacity. The choice of the optimized pressure will then depend on respective economical value of CO₂, CNG, and pipe steel. The pressure will preferably be 100 bar to 250 bar, more preferably 150 bar to 200 bar.

170 bar, which is a typical pressure used in the transportation of compressed natural gas (CNG) is currently considered to be a good optimization.

The term “off-shore” refers to a location in mid sea. Typical distances from the shore are 500 to 2500 km, preferably 1000-2000 km, more preferably 1500 to 2000 km. Although the term generally refers to receiving facilities in the ocean, for example an oil or gas rig, it can also refer to a different coast distant from the shore of origin. The latter would not resolve all of the background issues on account of which off-shore storage is preferred, but it will be understood that the invention is equally applicable to overseas transport ending on-shore rather than in mid-sea.

The present invention will further be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

It is furthermore to be noticed that the term “comprising”, used in the description and in the claims, should not be interpreted as being restricted to the means listed thereafter; it does not exclude other elements or steps. Thus, the scope of the expression “a facility comprising means A and B” should not be limited to facilities consisting only of components A and B. It means that with respect to the present invention, the only relevant components of the facility are A and B.

The method of the invention generally comprises the following stages:
a loading stage at an export terminal, where carbon dioxide captured from a source, such as a fossil fuel-based powerplant, and sent to a convenient place at shore, is loaded into a ship's containment system;
a transport stage by sea, with the carbon dioxide held in the ship's containment system;
an unloading stage at an off-shore receiving facility;
preferably loading CNG and transporting this back.

The method of the invention is not limited to any particular source of captured carbon dioxide. The capture of CO₂ from e.g. fossil fuel powerplants, chemical factories, greenhouses, and its transportation to the export terminal, and handling at said terminal, can be done in standard ways known to the skilled person. At the export terminal, the captured carbon dioxide will be retrieved from a CO₂ pipeline, generally in a supercritical state, and brought into a ship's containment system. According to the invention, and in deviation from the standard in the art, the latter will not be refrigerated, but will be in a liquid state as defined above.

In one embodiment, a middle pressure is applied, wherein the storage in the ship's containment system will be at a pressure within the aforementioned ranges, preferably at 75-80 bar. As compared to standard shipping at refrigerated conditions, basic advantages include the avoidance of cooling at the export terminal, of cooling and containment means for storage at refrigerated conditions in the ship, and the need for reheating at the receiving facility.

The ships to be used can comprise equipment for the containment of pressurized gas or liquids generally known in the art.

A further advantage of the invention, is that ships can be used comprising containment equipment that is based on tubular assembly using gas line pipes known in the art, with a type of assembly similar to the one generally applied for known CNG ship transportation. An advantage of the temperature and pressure scheme for the CO₂ transport according to the invention, is that it can be executed so as to match a desired pressure for CNG transport.

In the preferred high pressure embodiment, the same advantages will be enjoyed in general as in the middle pressure embodiment. At the export terminal, however, the practical and economical advantages are greater, as the quantity of CNG brought on the return ship is larger. Actually, at the receiving facility, this embodiment leads to a further advantage if the shipping of carbon dioxide is combined with shipping, reverse way (on the return trip), of compressed natural gas. The term “compressed natural gas” (CNG) is to be interpreted broadly as relating to any natural gas compressed at very high pressure in order to allow its transport in manageable volume. Preferably, the CNG and the CO₂ have substantially the same pressure.

In this embodiment, the loading and the unloading operation can be made very simple by displacement of the CO₂ by compressed natural gas. At unloading, the pressurized gas can be provided either at the same platform produced from another layer or area of the field, or from a nearby small field not connected to an export pipeline, and therefore providing a resource of stranded unexploited gas.

When arriving back at the export terminal, the natural gas is then displaced by the CO₂ to be loaded, and can be further sent into a network and to local consumers. Thus, the valorization of the natural gas can substantially offset most of the cost of the CO₂ transportation scheme.

A straight shuttle operation is conducted between two terminals, viz. one at which CO₂ is loaded (displacing CNG that is unloaded) and one at which CO₂ is unloaded (and being displaced by CNG).

In order for the foregoing conjunction of transport of CO₂ and CNG to be feasible, the quantities of CNG required for CO₂ displacement need not be large, in view of the much higher density of the CO₂ compared to the CNG density at the pressure considered. Taking into account that the value of CNG is much higher than that of sequestered CO₂, the invention provides a technical solution through which the gas valorization is able to offset a substantial part of the cost of CO₂ shipping.

It will be understood that the system used for the displacement must be so as to limit the area of contact between the CO₂ and the natural gas, to avoid pollution of the natural gas by CO₂ as well as to limit the content of natural gas in CO₂ liquid at the inlet of the reinjection pumps used for the eventual storage of CO₂. (Incidentally, the pollution of gas by CO₂ is not critical if the arriving gas is sent directly as fuel into a power plant without being mixed in a commercial network).

The foregoing can be realized by organizing a linear containment of tubes in series (i.e., a pipe like containment system), working similarly to a multi-product pipe with a limited polluted interface. In one embodiment a limited amount of an intermediate interface fluid could further reduce the potential interface pollution, i.e. a fluid preferably with a small diffusion factor in both natural gas and CO₂. Suitable pipes and interface fluids are known to the skilled person and do not require elucidation here. The system of tubular containment limits the interface as soon as the tubes are connected in series, the container acting then as within pipelines of several tens of kilometers.

The containment system will generally be divided into several linear containments stacked within the compartments of a double hull “tanker like” ship, where the CO₂ inlet/outlet is located at the bottom and the natural gas inlet/outlet is located at its top.

The containment can be realized with relatively cheap standard line pipes with two possible concepts:
(a) By longitudinal pipes of e.g. 48 m length (quadruple jointing) assembled on yard in bundles within a frame with connections by U type elbow allowing a continuous serial connection between tubes with one inlet and one outlet from the modules. Typically such module could be based on 28 inch (0.7112 m) pipes.
   Wall thickness of the pipe will be calculated in accordance with the pressure and the safety factor as requested by Norsk Veritas for CNG shipping.
   Number of 48 m strings in each module, and number of modules per hull compartment will depend on the manageable weight in the shipyard, and on pressure chosen and ship size.
   Typical figures are given in the table below:

| | Middle pressure | High pressure |
|---|---|---|
| | solution 75 bar | solution 170 bar |
| Pipe diameter | 28″ | 28″ |
| Pipe wall | 9.5 mm | 20.6 mm |
| thickness | | |
| Number of 48 m | 48 | 24 |
| strings per | | |
| module | | |
| Typical strings | 6 × 8 | 4 × 6 |
| assembly | | |
| Weight of one | 452 t | 494 t |
| module (empty)¹ | | |
| CO2 tonnage per | 762 t | 447 t |
| module | | |
| CNG tonnage per | 61 t | 90 t |
| module | | |
| Number of | 16 | 32 |
| modules on each | | |
| of the 3 ships | | |
| compartments | | |
| Total CO2 ship | 36,500 t | 42,900 t |
| capacity | | |

¹including fitting and supporting framework

(b) A second possible “pipe like” containment system is generally known as a Coselle system (the name being an acronym for “Coiled pipe in a carrousel) proposed for CNG at 220 bars by ENERSEA, which consists of small 6″ pipes coiled in coselles, with a typical size of 14.5 m diameter and 5 meters high coils of 16.5 km long pipes. The Coselle system is referred to, inter alfa, in http://www.coselle.com/coselle.php.

Transfer systems in the foregoing embodiment of CO₂/gas displacement, will need only two connections, one for CO₂ and one for gas. The displacement of one product by the other is implemented by small differential pressure between the products entering and leaving the ship, no pumps are needed on the ship. The connections can be realized, e.g., either by loading arms, or in a flexible manner at a berth, or through a turret type or any rotating system if off-shore mooring of the ship is considered.

The transport can be realized in a shuttle type operation, with no storage at either end. In this case, the ship is loaded or unloaded directly at the flow rate provided via of the CO₂ supply pipe. The shuttle operation is conducted with a number of ships allowing to permanently have one ship being unloaded and loaded at both CO₂ export terminal and CNG export terminal, so as to not substantially interrupt the flow of CO₂ and CNG at the loading and unloading terminals. It will be understood that the permanent character of this operation can also imply a relatively short intermission between departure of one ship, and the arrival of the other. In order to avoid flow rate interruption between ship permutation at berth (or mooring) either two berths are to be provided, or one berth with some buffer storage for the duration of the interruption. In this case, as a result, the fixed facilities at both ends can be limited to the CO₂ and gas connections at two berths (plus one small storage if only one berth is considered). Thus, in a preferred embodiment, the method of the invention is conducted in a shuttle operation employing a plurality of ships.

In another embodiment, the operation can also be realized without having a ship permanently connected to receive or send the CO₂. In that case a storage capacity at one or two ends of the ship round trip will be provided.

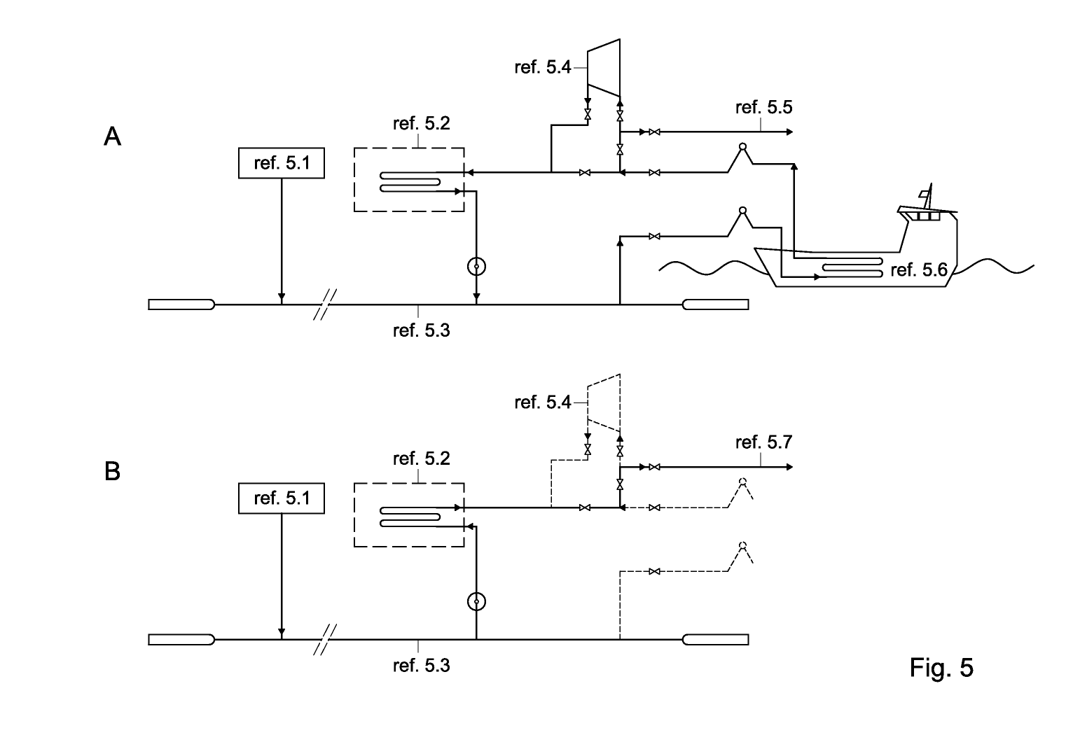

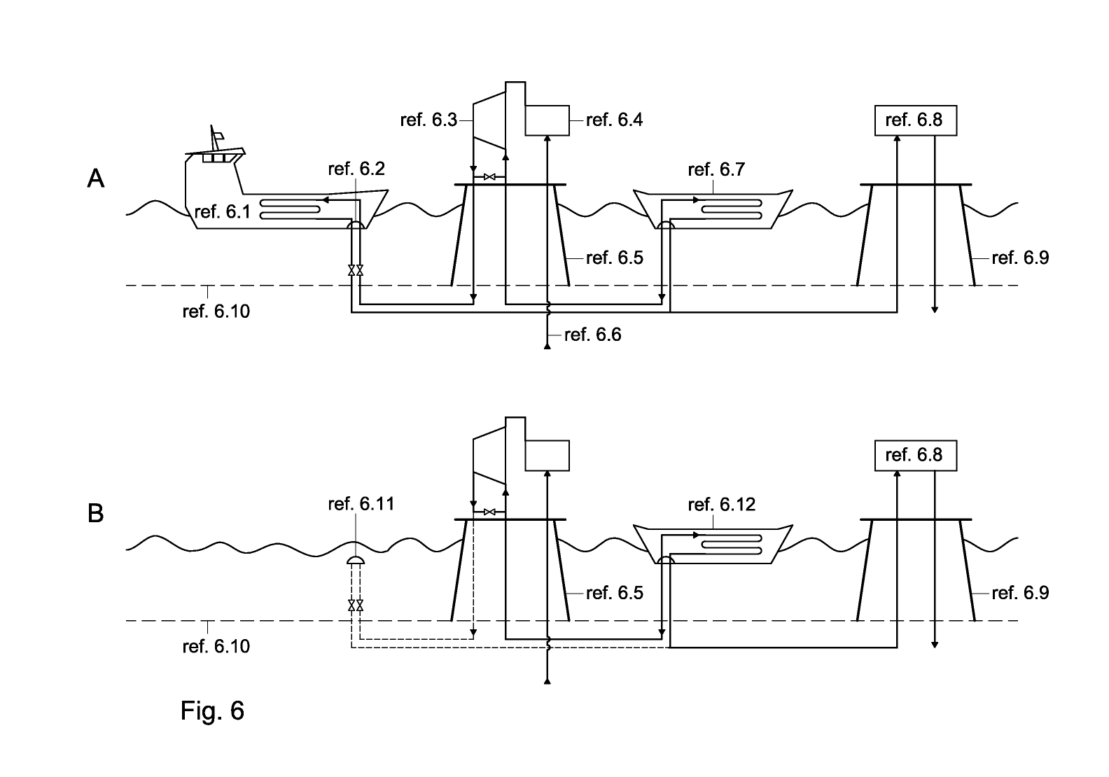

In one embodiment, the storage capacity at the terminals can be realized using the same type of tubular pipeline containment as mentioned above for the ship's containment system. Those pipes could be buried on shore, evenly along the feeding pipeline or, for off-shore, either laid up and buried in the sea bottom, or installed in a storing barge connected to the gas and CO₂ pipes connecting the ship and the CO₂ and gas platform. In this embodiment, the storage also, like in the ship's containment systems, can be operated by displacement of the interface in the pipe between CNG and CO₂. This will require a gas compressor of merely a few bars. In the invention, this type of storage is referred to as push-pull storage (depicted in FIGS. 5 and 6).

The embodiment of the invention in which CO₂/gas displacement takes place, also presents an advantage as compared to the customary transport of CNG. In the latter case, the containment systems used are subject to substantial compression-decompression cycles, resulting in thermal and mechanical effects.

The foregoing advantages of the conjunction of transport of CO₂ and CNG are the most prominent in the event of CO₂ transport at thigh pressure.

### EXAMPLE

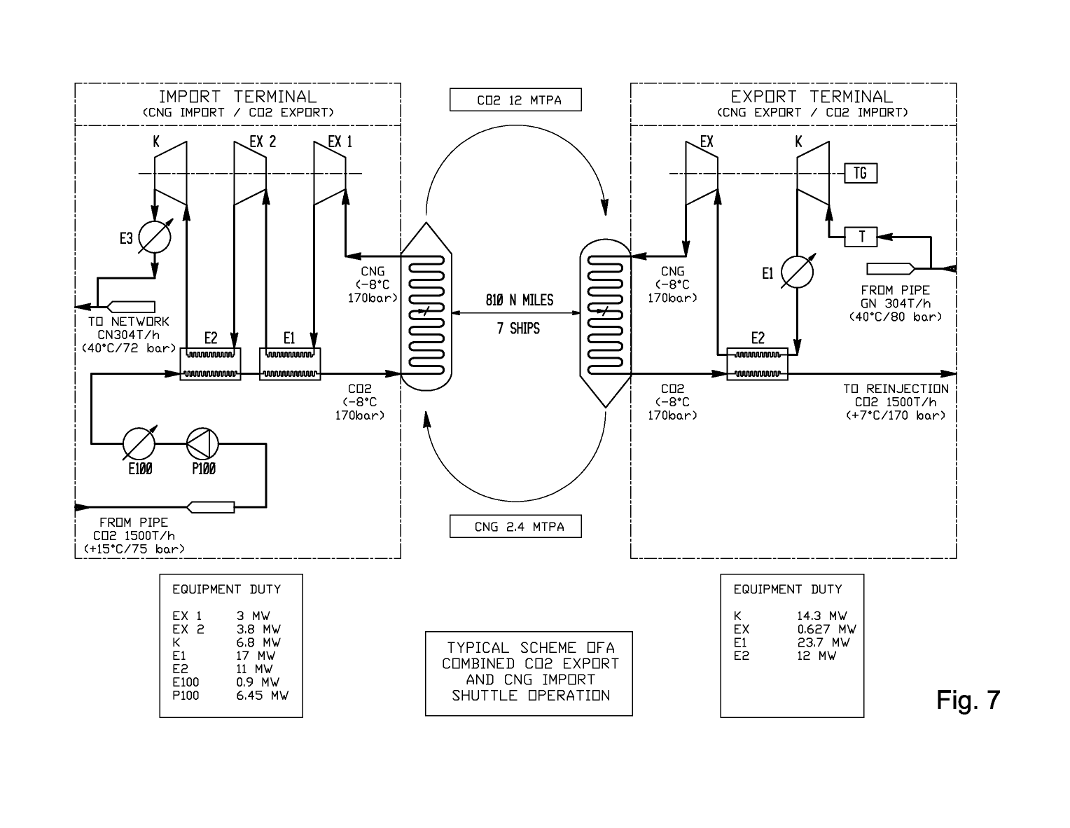

High pressure shipping (170 bar), as illustrated in FIG. 7.

A ship is used comprising a tubular containment system based on 28″ inches pipes with 20.6 mm thickness. The size of the ship is such as to be able to contain a total of 2.304 strings of 28″ 48 m length (split in 32 modules of 24 strings in each of the three ship's compartments).

The ship's size will be as follows:

| | |
|---|---|
| Length | 250 m |
| Beam | 44 m |
| Depth | 34 m |

Alternatively, the ship is provided with a “coselle” type of containment, using coselles made with 6″ pipe, as considered by “sea NG” company, leading to a larger ship size.

The total weight of the containment is 47,000 t, offering a volume of 40.500 m3 as internal volume.

The ship's containment system is operated at −8° C. in order to optimize the volume of stranded gas capacity which is favored by the higher gas compressibility factor at such a temperature.

The ship's 40.500 m³ internal volume provides a storage capacity of 42.708 t of CO₂. This allows to use 7 ships for exporting 12 MTPA at 1.500 km distance.

The round trip will then be 193 h with a loading/unloading duration of 28 h at each call, assuming a shuttle type of operation (without storage at the terminals) with 24 h of overlap margin. With each ship providing 42 round trips per year, the annual capacity per ship is 1,79 MTPA, and seven ships 12,55 MTPA.

Based on a gas specific gravity at 170 bars −8° C. of 0.21 kg/m³, the ship's CNG capacity is then 8.630 t. It means that the gas brought back to the market can reach 2.54 MTPA/year.

The export terminal will include a high pressure CO₂ pump facility to bring 1.500 t/h of CO₂ in supercritical state, from 75 bars to 175 bars, and a further cooling with sea water—This needs 3 (2+1) pumps of 3.3 MW. On the gas side it will have a two stages expander (1+1) working from 170 bars to 44 bars with a power delivered of 6.8 MW. A recompression, also (1+1) machine 6.8 MW if the pressure needed in the network is higher than 44 bars and assumed 72 bars, the drive being brought by the turbo-expander. Ship-shore transfer will be implemented by two high pressure loading arms.

The import terminal will include as its main process equipment a compression unit of two (1+1) compressors of 15 MW up to 191 bars, an after cooler exchanger of 24 MW, an exchanger with the CO₂ unloaded of 12 MW, two final expanders (1+1) to cool the gas at −8° C. from 190 bars to 173 bars. Ship to platform transfer will be implemented by a turret system.

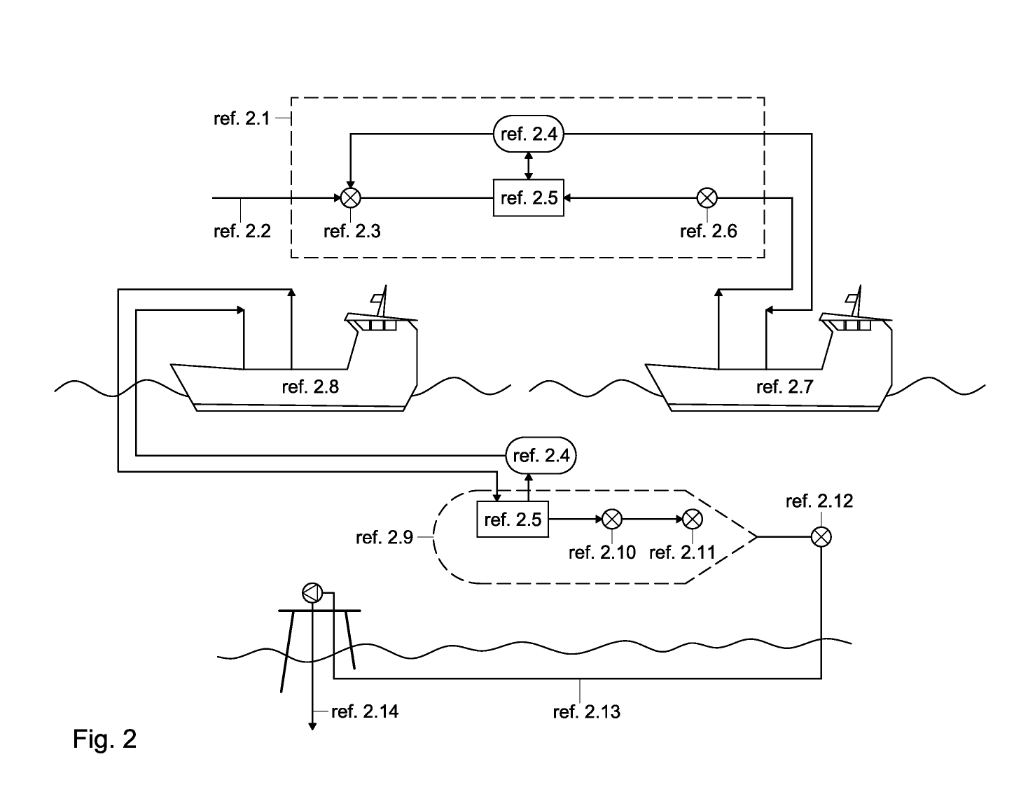

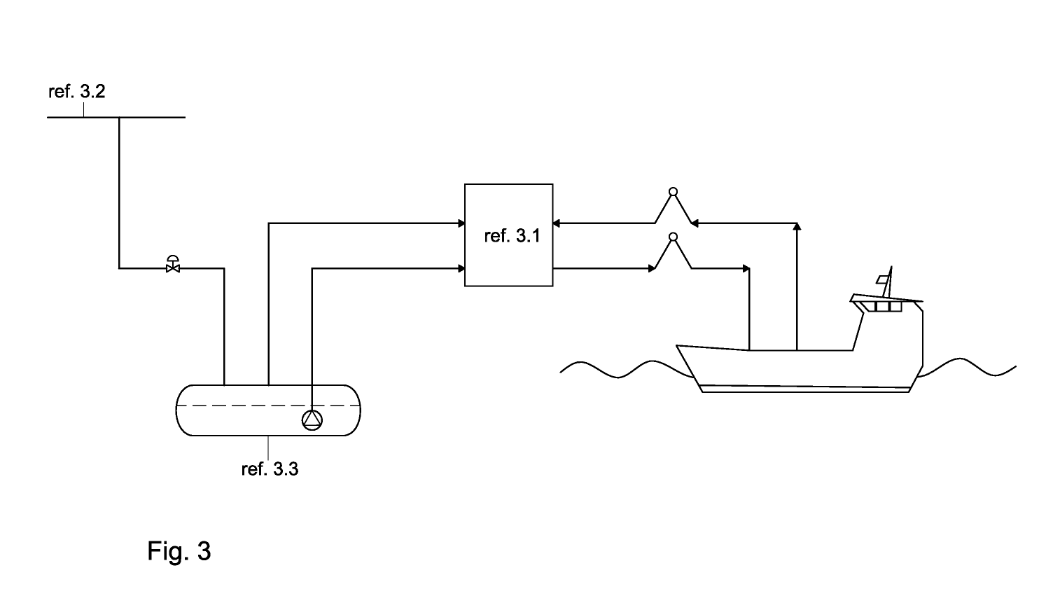

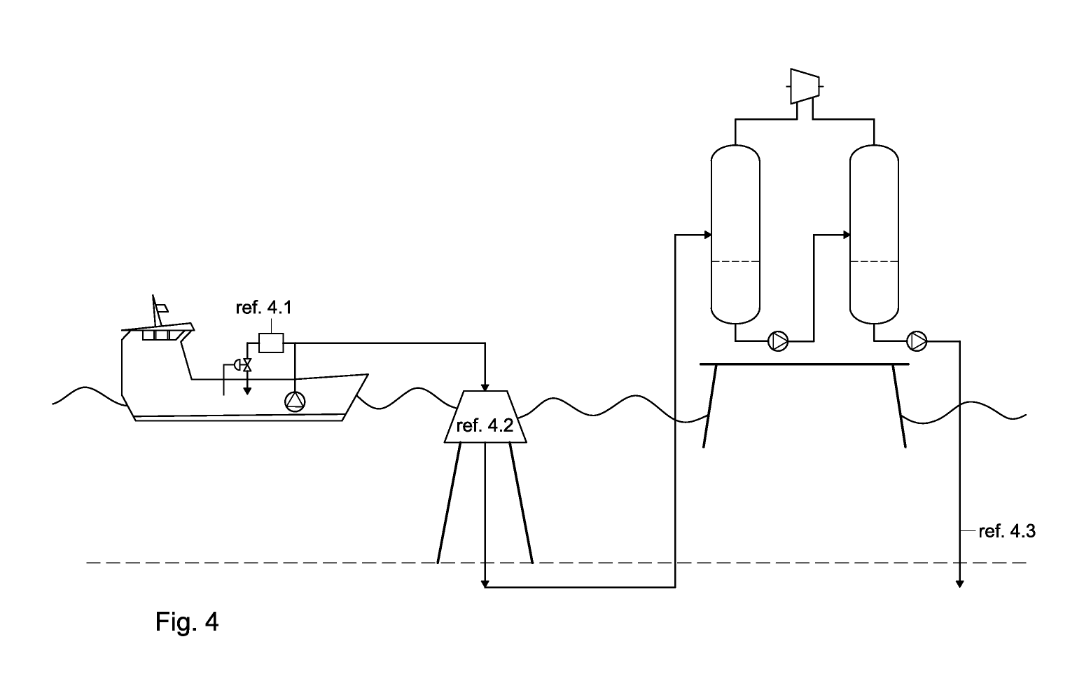

REFERENCE LIST TO FIGS. 2, 3, 4, 5 AND 6

ref. 2.1 EXPORT TERMINAL

ref. 2.2 HYPERCRITICAL PIPE

ref. 2.3 DEHYDRATION AND COOLING AT −45° C.

ref. 2.4 GAS RETURN

ref. 2.5 CRYOGENIC STORAGE

ref. 2.6 TRANSFER

ref. 2.7 SHIP LOADING

ref. 2.8 SHIP UNLOADING

ref. 2.9 RECEIVING FLOATING TERMINAL

ref. 2.10 HP PUMPING

ref. 2.11 HEATING

ref. 2.12 MOORING AND TRANSFER

ref. 2.13 OFF-SHORE PIPE

ref. 2.14 REINJECTION

ref. 3.1 RECONDENSING UNIT

ref. 3.2 HYPERCRITICAL PIPE

ref. 3.3 BUFFER STORAGE

ref. 4.1 REGASIFER

ref. 4.2 TURRET

ref. 4.3 REINJECTION

ref. 5.1 CO2 SEND OUT

ref. 5.2 PUSH PULL PIPE STORAGE

ref. 5.3 FEED PIPE TO TERMINAL

ref. 5.4 GAS COMPRESSOR

ref. 5.5 EXCESS GAS TO LOCAL USERS

ref. 5.6 SHIP LOADED

ref. 5.7 GAS TO LOCAL USERS

ref. 6.1 UNLOADING SHIP

ref. 6.2 TURRET MOORING

ref. 6.3 GAS COMPRESSOR

ref. 6.4 GAS PRODUCTION UNIT

ref. 6.5 GAS PLATFORM

ref. 6.6 STRANDED GAS PRODUCTION

ref. 6.7 PUSH PULL STORING BARGE

ref. 6.8 CO2 REINJECTION

ref. 6.9 CO2 PLATFORM

ref. 6.10 SEA FLOOR

ref. 6.11 TURRET

ref. 6.12 PUSH PULL UNSTORING BARGE

1. A method for transporting captured carbon dioxide (CO₂) to an off-shore location,
wherein the CO₂ is transported by ship, with the CO₂ being at a temperature between −25° C. and +25° C., and under a pressure that is sufficiently high for the CO₂ to be in a liquid state,
wherein the transport of CO₂ is combined with transport of compressed natural gas (CNG), such that one way a ship transports CO₂ and the reverse way the ship transports the CNG,
wherein one or more ships are used having tubular containment equipment for the storage of CO₂, and
wherein the CO₂ and the CNG have substantially the same pressure.

2. The method of claim 1, wherein the pressure is above the critical pressure of CO₂.

3. The method of claim 2, wherein the pressure is between 100 bar and 250 bar.

4. The method of claim 3, wherein the pressure is between 165 bar and 175 bar.

5. The method of claim 1, wherein the temperature of the CO₂ is -15° C. to 10° C..

6. The method of claim 5, wherein the temperature of the CO₂ is −8° C. to 0° C.

7. The method of claim 1, wherein the temperature is determined at the stage of loading the CO₂ into the ship.

8. The method of claim 1, wherein the loading and unloading of CO₂ and CNG is conducted by allowing CNG to displace CO₂ upon unloading of CO₂ and allowing CO₂ to displace CNG upon unloading of CNG.

9. The method of claim 8, wherein the CO₂ and the CNG are loaded under substantially the same pressure and temperature.

10. The method of claim 9, wherein the pressure is 165 bar to 175 bar, and the temperature upon loading the gas into the ship is −15° C. to 0° C.

11. The method of claim 1, conducted in a shuttle operation employing a plurality of ships.

12. The method of claim 11, wherein the shuttle operation is conducted with a number of ships allowing to permanently have one ship being unloaded and loaded at either or both of a CO₂ export terminal and a CNG export terminal, so as to not substantially interrupt the flow of CO₂ and CNG at either or both of the loading and unloading terminals.

13. The method of claim 8, wherein the operation is conducted with a storage facility at one or both ends of the shipping.

14. The method of claim 13, wherein CO₂ is loaded or unloaded in the storage by displacement of an interface with natural gas.

15. The method of claim 3, wherein the pressure is between 150 bar and 200 bar.

16. The method of claim 5, wherein the temperature of the CO₂ −10° C. to +5° C.

17. The method of claim 8, wherein the CO₂ and the CNG are transported under substantially the same pressure.

18. The method of claim 10, wherein the pressure is 170 bar.

19. The method of claim 10, wherein temperature upon loading the gas into the ship is −8° C.

20. The method of claim 13, wherein the storage facility comprises a pipeline containment.
